(19) United States
(12) Patent Application Publication
(10) Pub. No.: US 2011/0076938 A1
(43) Pub. Date: Mar. 31, 2011

(54) WIRELESS COMMUNICATION APPARATUS AND WIRELESS COMMUNICATION METHOD

(75) Inventor: Hidehiro Eguchi, Yokohama-shi (JP)

(73) Assignee: KYOCERA CORPORATION, KYOTO (JP)

(21) Appl. No.: 12/994,826

(22) PCT Filed: May 29, 2009
(86) PCT No.: PCT/JP2009/059893

§ 371 Date: Nov. 26, 2010

(30) Foreign Application Priority Data
May 29, 2008 (JP) 2008-140747
May 29, 2008 (JP) 2008-140854

(51) Int. Cl. H04B 3/36

(52) U.S. Cl. 455/7

(57) ABSTRACT

A wireless communication apparatus has a communication quality obtaining unit for obtaining communication quality of a radio propagation path with a communication counterpart, a retransmission number control unit for controlling the number of retransmissions at a predetermined first frequency based on the communication quality obtained by the communication quality obtaining unit, and a retransmission control unit for controlling retransmission such that retransmission over the number of retransmissions controlled by the retransmission number control unit is performed at a second frequency set with the communication counterpart.

### CROSS REFERENCE TO RELATED APPLICATIONS

This application claims priority to and the benefit of Japanese Patent Application No. 2008-140854 filed on May 29, 2008 and Japanese Patent Application No, 2008-140747 filed on May 29, 2008, the entire contents of which are incorporated herein by reference.

### TECHNICAL FIELD

The present invention relates to wireless communication apparatuses and wireless communication methods to retransmit data to a communication counterpart by using a predetermined frequency.

### BACKGROUND ART

As a communication scheme dynamically assigning a time and frequency resource, there is “LTE (Long Term Evolution)” positioned as 3.9G by 3GPP (3rd Generation Partnership Project), for example. For such communication system which dynamically assigns the time and frequency resource, a method has been considered to fixedly assign radio resources, for the purpose of reducing overhead in packet communication (for example, VoIP (Voice Over Internet Protocol)) which maintains a stable communication traffic to an extent.

FIG. 11 is a diagram illustrating an exemplary fixed scheduling (conventional example 1) which fixedly assigns resources for retransmission at a predetermined frequency channel at every second unit times. In the figure, resources with diagonal lines from upper right to lower left are fixedly assigned. This exemplary fixed scheduling secures four resources for retransmission in total including resources at every second unit times on the same frequency channel after first transmission of data to the communication counterpart, forming one data transmission period as 10 unit times. Since data are retransmitted twice by fixed assignment to the communication counterpart after a first transmission in a first transmission period, it generates two empty resources (resources with diagonal lines from upper left to lower right in the figure) without retransmission. In addition, since data are retransmitted once by fixed assignment to the communication counterpart after the first transmission in a next transmission period, it generates three empty resources (resources with diagonal lines from upper left to lower right in the figure) without retransmission.

In order to avoid generation of such empty resource which will be unused, “example of first fixed transmission and dynamic retransmission scheduling” (conventional example 2) as shown in FIG. 12 is suggested. This scheduling fixedly assigns only first transmission corresponding to a resource with diagonal lines from upper right to lower left in the figure and dynamically assigns resources at retransmission corresponding to resources with a mesh pattern in the figure.

### SUMMARY OF INVENTION

### Technical Problem

Since the fixed scheduling of the conventional example 1 generates the empty resources as shown in FIG. 11 in an environment with good communication quality, it causes a problem that the resource cannot be utilized effectively unless the resource is dynamically reassigned to a different user. Such environment with good communication quality may be, for example, when the communication counterpart is not moving or is moving very slowly and the like.

In addition, since the first fixed transmission and dynamic retransmission scheduling of the conventional example 2 causes many retransmissions (that is, dynamic assignment) in an environment with deteriorated radio condition, which causes a problem to increase overhead. Such environment with deteriorated radio condition may be when fading is increased because the communication counterpart is moving at a high speed.

An object of the present invention is to provide a scheme (wireless communication apparatus and wireless communication method) for a communication scheme fixedly assigning resources at a predetermined frequency, to improve frequency usage efficiency, by optimizing both of the empty resource at retransmission and overhead by dynamic assignment.

### Solution to Problem

In order to achieve the above object, a wireless communication apparatus for performing retransmission of data to a communication counterpart by using a predetermined frequency according to a first aspect of the present invention includes:

a communication quality obtaining unit for obtaining communication quality of a radio propagation path with the communication counterpart;

a retransmission number control unit for controlling a number of retransmissions at a predetermined first frequency based on the communication quality obtained by the communication quality obtaining unit; and

a retransmission control unit for controlling the retransmission such that retransmission over the number of retransmissions controlled by the retransmission number control unit is performed at a second frequency set with the communication counterpart.

A second aspect of the present invention is that, in the wireless communication apparatus according to the first aspect,

the retransmission number control unit controls the number of retransmissions to be decreased as the communication quality obtained by the communication quality obtaining unit is higher.

A third aspect of the present invention is that, in the wireless communication apparatus according to the first or the second aspect,

the retransmission number control unit controls the number of retransmissions such that retransmission at the first frequency is stopped if the communication quality obtained by the communication quality obtaining unit exceeds a predetermined communication quality.

In order to achieve the above object, a wireless communication method for performing retransmission of data to a communication counterpart by using a predetermined frequency according to a fourth aspect of the present invention includes the steps of:

obtaining communication quality of a radio propagation path with the communication counterpart;

controlling a number of retransmissions at a predetermined first frequency based on the communication quality obtained at the step of obtaining the communication quality; and

controlling the retransmission such that retransmission over the number of retransmissions controlled at the step of controlling the number of retransmissions is performed at a second frequency set with the communication counterpart.

In addition, in order to achieve the above object, a wireless communication apparatus for performing retransmission of data to a communication counterpart by using a predetermined frequency according to a fifth aspect of the present invention includes:

a moving speed obtaining unit for obtaining a moving speed of the communication counterpart;

a retransmission number control unit for controlling a number of retransmissions at a predetermined first frequency based on the moving speed of the communication counterpart obtained by the moving speed obtaining unit; and

a retransmission control unit for controlling the retransmission such that retransmission over the number of retransmissions controlled by the retransmission number control unit is performed at a second frequency set with the communication counterpart.

A sixth aspect of the present invention is that, in the wireless communication method according to the fifth aspect,

the retransmission number control unit controls the number of retransmissions to be decreased as the moving speed of the communication counterpart obtained by the moving speed obtaining unit is slower.

A seventh aspect of the present invention is the wireless communication apparatus according to the fifth or the sixth aspect,

the retransmission number control unit controls the number of retransmissions such that retransmission at the first frequency is stopped if the moving speed of the communication counterpart obtained by the moving speed obtaining unit is slower than a predetermined speed.

An eighth aspect of the present invention is that, in the wireless communication apparatus according to any one of the fifth to the seventh aspects,

the moving speed obtaining unit obtains the moving speed of the communication counterpart by being notified of the moving speed of the communication counterpart measured by the communication counterpart.

Moreover, in order to achieve the above object, a wireless communication method for performing retransmission of data to a communication counterpart by using a predetermined frequency according to a ninth aspect of the present invention includes the steps of:

obtaining a moving speed of the communication counterpart;

controlling a number of retransmissions at a predetermined first frequency based on the moving speed of the communication counterpart obtained at the step of obtaining the moving speed; and

controlling the retransmission such that retransmission over the number of retransmissions controlled at the step of controlling the number of retransmissions is performed at a second frequency set with the communication counterpart.

### BRIEF DESCRIPTION OF DRAWINGS

FIG. 1 is a block diagram illustrating a schematic constitution of a wireless communication apparatus (base station) according to a first embodiment of the present invention;

FIG. 2 is a flowchart of an exemplary assigning method determination procedure in a wireless communication method performed by the wireless communication apparatus (base station) according to the first embodiment;

FIG. 3 is a diagram illustrating an exemplary operation of the assigning method determination procedure in FIG. 2;

FIG. 4 is a flowchart of an exemplary assigning method changing procedure in the wireless communication method performed by the wireless communication apparatus (base station) according to the first embodiment;

FIG. 5 is a block diagram illustrating a schematic constitution of a wireless communication apparatus (base station) according to a second embodiment of the present invention;

FIG. 6 is a flowchart of exemplary procedure for a communication counterpart (terminal) to obtain a moving speed to be used with a wireless communication method performed by the wireless communication apparatus (base station) according to the second embodiment;

FIG. 7 is a diagram of exemplary assigning method determination sequence in the wireless communication method performed by the wireless communication apparatus (base station) according to the second embodiment, in which the wireless communication apparatus (base station) obtains the moving speed of the communication counterpart (terminal) from the terminal and instructs the communication counterpart (terminal) on the number of retransmissions and the like;

FIG. 8 is a flowchart of exemplary assigning method determination procedure in the wireless communication method performed by the wireless communication apparatus (base station) according to the second embodiment;

FIG. 9 is a diagram illustrating an exemplary operation of assigning method changing procedure in FIG. 8;

FIG. 10 is a flowchart of exemplary assigning method changing procedure in the wireless communication method performed by the wireless communication apparatus (base station) according to the second embodiment;

FIG. 11 is a diagram illustrating an exemplary fixed scheduling (conventional example 1) for fixedly assigning resources for retransmission to a predetermined frequency; and

FIG. 12 is a diagram illustrating exemplary first fixed transmission and dynamic retransmission scheduling (conventional example 1) for fixedly assigning a resource for only first transmission at a predetermined frequency channel and dynamically assigning resources for retransmission thereafter.

### DESCRIPTION OF EMBODIMENTS

Embodiments of the present invention will be described with reference to the accompanying drawings.

### First Embodiment

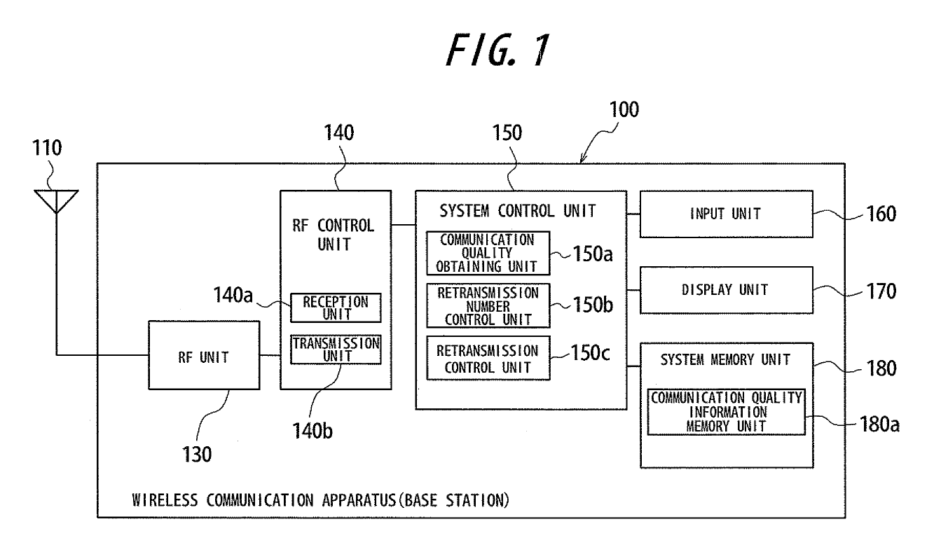

FIG. 1 is a block diagram illustrating a schematic constitution of a wireless communication apparatus according to a first embodiment of the present invention. A wireless communication apparatus (base station) 100 according to the first embodiment can perform data communication corresponding to a predetermined communication scheme (LTE, for example). As shown in FIG. 1, the wireless communication apparatus (base station) 100 has an antenna 110, an RF unit 130, an RF control unit 140, a system control unit 150, an input unit 160, a display unit 170, a system memory unit 180 and the like. The RF control unit 140 has a reception unit 140a and a transmission unit 140b. The system control unit 150 has a communication quality obtaining unit 150a, a retransmission number control unit 150b and a retransmission control unit 150c. The system memory unit 180 has a communication quality information memory unit 180a.

The RF unit 130 converts data to be transmitted by the predetermined communication scheme into a high frequency signal and transmits the high frequency signal from the antenna 110, as well as converting a high frequency signal input from the antenna 110 into a data signal. The RF control unit 140 controls communication (transmission and reception) of the predetermined communication scheme and measures field strength (RSSI and the like) of a signal received by the antenna from the wireless communication apparatus (terminal) of a communication counterpart. In addition, the RF control unit 140 functions as the reception unit 140a and the transmission unit 140b correspondingly to the data signal input from the RF unit 130 and the data signal output to the RF unit 130.

The system control unit 150 functions as a control unit for controlling each unit of the base station 100 overall.

The communication quality obtaining unit 150a obtains communication quality of a radio propagation path with the communication counterpart (terminal). The communication quality obtained by the communication quality obtaining unit 150a is stored as communication quality information, such as SINR, CINR, Doppler frequency and the like of uplink or downlink, in the communication quality information memory unit 180a of the system memory unit 180. At this point, when using uplink information, the wireless communication apparatus (base station) 100 obtains this information by measuring a transmission signal of the communication counterpart (terminal). When using downlink information, the wireless communication apparatus (base station) 100 obtains this information by receiving a feedback signal from the communication counterpart (terminal).

Levels of the communication quality may be represented in stages by communication quality level 1, communication quality level 2, communication quality level 3, for example. Here, the communication quality level 1 represents the highest communication quality, the communication quality level 2 represents the next highest communication quality, and the communication quality is lower as the number of the level is greater.

Table 1 shows an exemplary definition of the communication quality level. In the example shown in Table 1, it is defined as the communication quality level 1 when transmission of equal to or over 50% is succeeded with zero retransmission (without retransmission). In addition, it is defined as the communication quality level 2 when transmission of equal to or over 50% is succeeded with one retransmission, whereas it is defined as the communication quality level 3 when transmission of equal to or over 50% is succeeded with two retransmissions. A communication quality level 4 and lower communication quality levels are defined in this manner, as necessary.

It is to be noted that definitions of the communication quality levels shown in Table 1 are not limited to the above description but may be modified in a variety of manners as necessary. For example, if a priority is put on “reduction in overhead in dynamic assignment” than “reduction in empty resources when there is no retransmission”, “50%” in the above definitions of the communication quality levels are replaced with “a predetermined value under 50%”, In contrast, if a priority is put on “reduction in empty resources when there is no retransmission” than “reduction in overhead in dynamic assignment”, “50%” in the above definitions of the communication quality levels are replaced with “a predetermined value over 50%”.

TABLE 1

| Communication Quality Level | Definition |
|---|---|
| 1 | transmission of equal to or over 50% is |
| | succeeded with 0 retransmission |
| 2 | transmission of equal to or over 50% is |
| | succeeded with 1 retransmission |
| 3 | transmission of equal to or over 50% is |
| | succeeded with 2 retransmissions |
| . | . |
| . | . |
| . | . |

Based on the communication quality obtained by the communication quality obtaining unit 150a, the retransmission number control unit 150b controls the number of retransmissions at a predetermined first frequency. Particularly, the retransmission number control unit 150b sets the number of retransmissions by fixed assignment based on a relationship between the communication quality level and the number of retransmissions shown in Table 1. At this point, as shown in Table 1, the retransmission number control unit 150b controls such that the number of retransmissions is increased as the communication quality (communication quality level) obtained by the communication quality obtaining unit 150a is lower and the number of retransmissions is decreased as the communication quality (communication quality level) obtained by the communication quality obtaining unit 150a is higher. Also, if the communication quality (communication quality level) obtained by the communication quality obtaining unit 150a exceeds a predetermined communication quality (for example, if the communication quality level 1, which is the highest communication quality, is applicable), the retransmission number control unit 150b controls the number of retransmissions to be zero such that retransmission at the first frequency is stopped.

The retransmission control unit 150c controls such that retransmission is performed at the first frequency as many times as the number of retransmissions controlled by the retransmission number control unit 150b and retransmission over the number of retransmissions controlled by the retransmission number control unit 150b is performed at a second frequency which is arbitrarily set with the communication counterpart (terminal). In this case, the second frequency may be either different from or the same as the first frequency. In addition, if the retransmission number control unit 150b controls the number of retransmissions to be zero such that retransmission at the first frequency is stopped, the retransmission control unit 150e performs all retransmissions at the second frequency (all retransmissions by dynamic assignment).

The input unit 160 has a variety of keys and buttons and is used for inputting information or for selecting either one of options displayed on a display screen of the display unit 170. The input unit 160 and the display unit 170 may be omitted if desired.

The system memory unit 180 is a memory such as RAM and the like and stores an application program and temporary data. The communication quality information memory unit 180a stores the communication quality obtained by the communication quality obtaining unit 150a as the communication quality information such as uplink SINR, downlink SINR, CINR, Doppler frequency and the like.

[Flowchart of Assigning Method Determination Procedure]

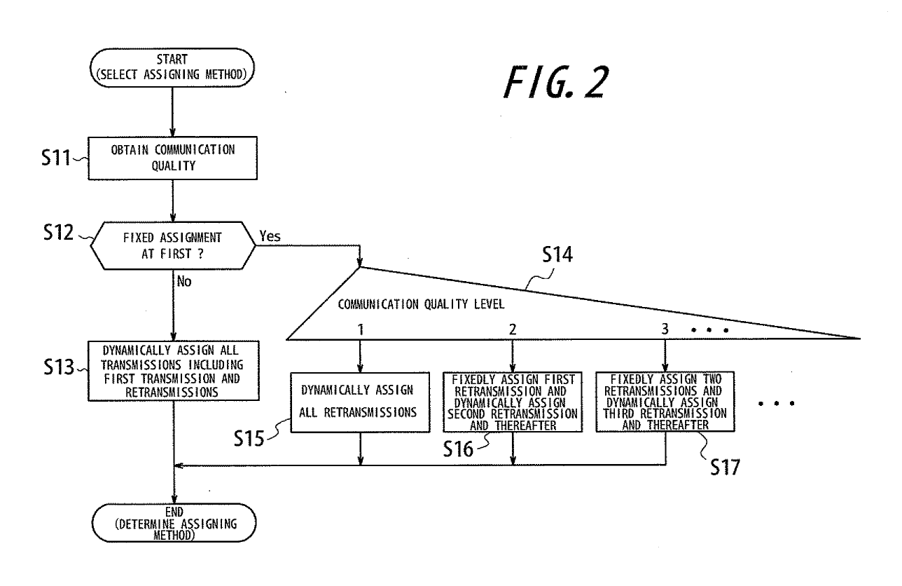

FIG. 2 is a flowchart of exemplary assigning method determination procedure in a wireless communication method performed by the wireless communication apparatus (base station) 100 according to the first embodiment. The assigning method determination procedure shown in FIG. 2 is initiated at start of communication (start of radio access).

First, at step S11, the communication quality obtaining unit 150a obtains the communication quality (communication quality level) of the radio propagation path with the communication counterpart (terminal). Then, at next step S12, the retransmission number control unit 150b determines whether a first transmission of data to the communication counterpart (terminal) is by fixed assignment, If the first transmission is not by fixed assignment at step 512, the retransmission number control unit 150b proceeds to step S13 to dynamically assign all transmissions including the first transmission and retransmissions. In contrast, if the first transmission is by fixed assignment at step S12, the retransmission number control unit 150b proceeds to step S14. At step S12, determination whether the first transmission of the data to the communication counterpart (terminal) is by fixed assignment is performed based on QoS (Quality of Service), for example.

At step S14, the retransmission number control unit 150b, based on the communication quality obtained by the communication quality obtaining unit 150a at step S11, fixedly assigns retransmissions as many times as the number of retransmissions at the predetermined first frequency and dynamically assigns retransmission over the number of retransmissions at the second frequency. That is, at step S14, the retransmission number control unit 150b first determines which one of the communication quality level 1, the communication quality level 2, the communication quality level 3, . . . the communication quality obtained at step S11 corresponds to. Then, based on such determination, the retransmission number control unit 150b proceeds to step S15 if the communication quality corresponds to the communication quality level 1, to step S16 if the communication quality corresponds to the communication quality level 2, and to step S17 if the communication quality corresponds to the communication quality level 3, so as to perform processing at each of the steps.

In case of the communication quality level 1, which is the highest communication quality, the process flow proceeds to step S15, where since it is in an environment with excellent communication quality and a probability to generate retransmission is low and thus generation of an empty resource is reduced, dynamic assignment for all retransmissions can provide effective communication. In consideration of that, the retransmission number control unit 150b controls the number of retransmission to be zero so as to stop retransmission (by fixed assignment) on the predetermined first frequency and dynamically assigns all retransmissions at the second frequency. In case of the communication quality level 2, which is the second highest communication quality, the process flow proceeds to step S16, where the retransmission number control unit 150b limits the number of retransmissions by fixed assignment to one and fixedly assigns first retransmission but dynamically assigns second retransmission and retransmissions thereafter. In case of the communication quality level 3, which is in an environment with deteriorated communication quality, the process proceeds to step S17, where many retransmissions are generated and thus fixed assignment up to a predetermined number of retransmissions reduces overhead in dynamic assignment. In consideration of that, the retransmission number control unit 150b sets the number of retransmissions by fixed assignment to two such that two retransmissions are fixedly assigned and third retransmission and retransmissions thereafter are dynamically assigned.

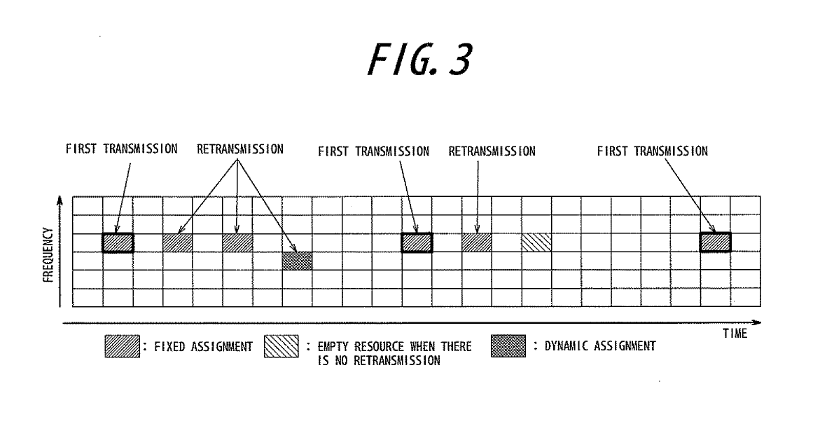

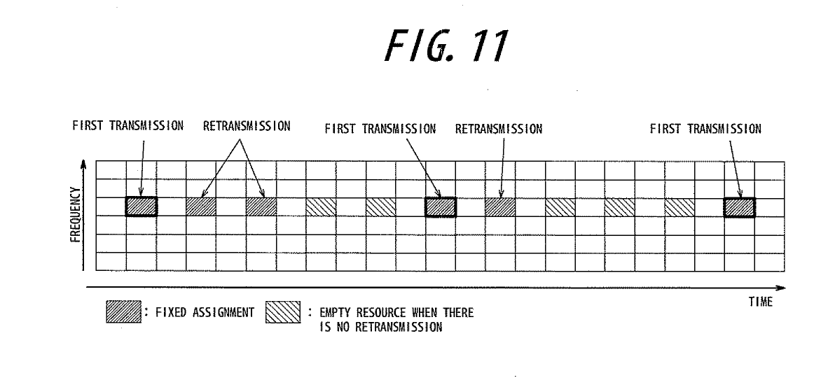

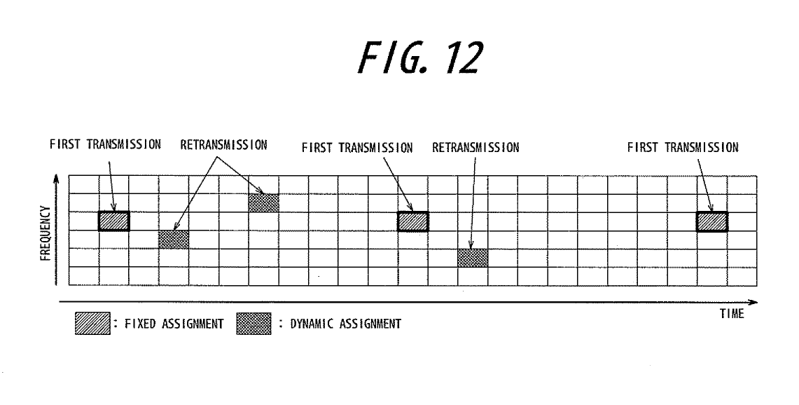

FIG. 3 is a diagram illustrating an exemplary operation of the assigning method determination procedure described with reference to FIG. 2. FIG. 3 shows “an example of operation of exemplary scheduling to fixedly assign two retransmissions and dynamically assign retransmissions thereafter”. In a first transmission period in FIG. 3 corresponding to step S17 in FIG. 2, data are retransmitted twice by fixed assignment to the communication counterpart after a first transmission and then retransmitted once by dynamic assignment. Therefore, no empty resource without retransmission is generated and retransmission of the data with dynamic assignment is performed only once. Accordingly, overhead in FIG. 3 is reduced to amount for one dynamic assignment, although overhead in dynamic assignment of the conventional example 2 shown in FIG. 12 is for two dynamic assignments. In addition, in a next transmission period in FIG. 3 corresponding to step S17 in FIG. 2, data are retransmitted by fixed assignment to the communication counterpart only once after the first transmission. Therefore, one empty resource without retransmission is generated in FIG. 3, although the number of empty resources is dramatically decreased in comparison with the conventional example 1 shown in FIG. 11, which has three empty resources for retransmissions.

In the wireless communication apparatus (base station) and the wireless communication method performed by the wireless communication apparatus (base station) according to the first embodiment, the assigning method determination procedure shown in FIG. 2 is performed. That is, at start of communication, the number of retransmissions by fixed assignment is controlled so as to be increased as the communication quality is lower and so as to be decreased as the communication quality level is higher, and retransmission only as many times as the number of retransmissions is performed on the predetermined first frequency. On the other hand, with regard to retransmissions over the number of retransmissions, the number of retransmissions by dynamic assignment is controlled to be increased as the communication quality level is higher and retransmissions only as many times as the number of retransmissions by dynamic assignment are performed at the second frequency arbitrarily set with the communication counterpart (terminal). Accordingly, according to the first embodiment, the number of retransmissions by fixed assignment is increased according to communication quality as the communication quality is deteriorated, and the number of retransmissions by fixed assignment is decreased and the number of retransmissions by dynamic assignment is increased as the communication quality is higher. Thereby, since it is possible to reduce and optimize both of the empty resources at retransmission and overhead by dynamic assignment, it improves frequency usage efficiency.

[Flowchart of Assigning Method Changing Procedure]

According to the assignment method determination procedure shown in FIG. 2, a timing to determine the assigning method is at start of communication. However, it is preferred that the assigning method determined at start of communication may be changed during communication (when transmission packets are generated) in accordance with change in the communication quality thereafter.

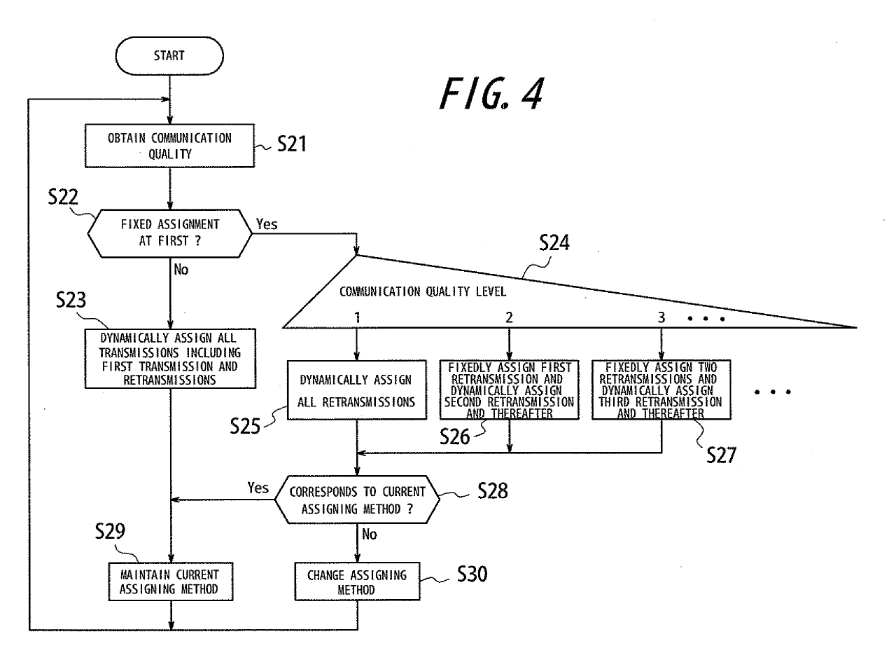

FIG. 4 is a flowchart of exemplary assigning method changing procedure in the wireless communication method performed by the wireless communication apparatus (base station) 100 according to the first embodiment. The assigning method changing procedure shown in FIG. 4 changes the assigning method determined in the assigning method determination procedure shown in FIG. 2 in accordance with change in the communication quality and is performed at predetermined intervals,

In the assigning method changing procedure, first, the communication quality obtaining unit 150a obtains the communication quality (communication quality level) of the radio propagation path with the communication counterpart (terminal) at step S21. Then, at step S22, the retransmission number control unit 150b determines whether the first transmission of data to the communication counterpart (terminal) is by fixed assignment. If the first transmission is not by the fixed assignment at step S22, the retransmission number control unit 150b proceeds to step S23 to dynamically assign all transmissions including the first transmission and retransmissions. In contrast, if the first transmission is by fixed assignment at step S22, the retransmission number control unit 150b proceeds to step S24. At step S12, determination whether the first transmission of the data to the communication counterpart (terminal) is by fixed assignment is performed based on QoS (Quality of Service), for example.

At step S24, the retransmission number control unit 150b, based on the communication quality obtained by the communication quality obtaining unit 150a at step S21, fixedly assigns retransmissions as many times as the number of retransmissions at the predetermined first frequency and dynamically assigns retransmission over the number of retransmissions at the second frequency. That is, at step S24, the retransmission number control unit 150b first determines which one of the communication quality level 1, the communication quality level 2, the communication quality level 3, . . . the communication quality obtained at step S11 corresponds to. Then, based on such determination, the retransmission number control unit 150b proceeds to step S25 if the communication quality corresponds to the communication quality level 1, to step S26 if the communication quality corresponds to the communication quality level 2, and to step S27 if the communication quality corresponds to the communication quality level 3, so as to perform processing at each of the steps.

In case of the communication quality level 1, which is the highest communication quality, the process flow proceeds to step S25, where since it is in an environment with excellent communication quality and a probability to generate retransmission is low and thus generation of an empty resource is reduced, dynamic assignment for all retransmissions can provide effective communication. In consideration of that, the retransmission number control unit 150b controls the number of retransmission to be zero so as to stop retransmission (by fixed assignment) on the predetermined first frequency and dynamically assigns all retransmissions at the second frequency. In case of the communication quality level 2, which is the second highest communication quality, the process flow proceeds to step S26, where the retransmission number control unit 150b limits the number of retransmissions by fixed assignment to one and fixedly assigns first retransmission but dynamically assigns second retransmission and retransmissions thereafter. In case of the communication quality level 3, which is in an environment with deteriorated communication quality, the process flow proceeds to step S27, where many retransmissions are generated and thus fixed assignment up to a predetermined number of retransmissions reduces overhead in dynamic assignment. In consideration of that, the retransmission number control unit 150b sets the number of retransmissions by fixed assignment to two such that two retransmissions are fixedly assigned and third retransmission and retransmissions thereafter are dynamically assigned.

At the next step S28, the retransmission number control unit 150b determines whether the assigning method determined at step S25, step S26 or step S27 corresponds to a current assigning method. If the assigning method determined at a previous step (step S25, step S26 or step S27) corresponds to the current assigning method at step S28, the retransmission number control unit 150b proceeds to step S29 to maintain the current assigning method. In contrast, if the assigning method determined at the previous step does not correspond to the current assigning method at step S28, the retransmission number control unit 150b proceeds to step S30 to switch to the assigning method determined at step S25, step S26 or step S27. After execution of steps S29 and S30, the retransmission number control unit 150b returns to step S21 to repeat the assigning method changing procedure stated above. Therefore, when transmission packets are generated, the assigning method is changed in accordance with change in the communication quality, as necessary.

According to the wireless communication apparatus (base station) and the wireless communication method performed by the wireless communication apparatus (base station) according to the first embodiment, the assigning method determination procedure shown in FIG. 4 is performed. That is, not only at start of communication but also during communication, the number of retransmissions by fixed assignment is controlled so as to be increased as the communication quality is lower and so as to be decreased as the communication quality level is higher, and retransmission only as many times as the number of retransmissions is performed at the predetermined first frequency. On the other hand, with regard to retransmissions over the number of retransmissions at the first frequency, the number of retransmissions by dynamic assignment is controlled to be increased as the communication quality level is higher and retransmissions as many times as the number of retransmissions by dynamic assignment are performed by using the second frequency arbitrarily set with the communication counterpart (terminal). Accordingly, according to the first embodiment, the number of retransmissions by fixed assignment is increased as the communication quality is deteriorated, and the number of retransmissions by fixed assignment is decreased and the number of retransmissions by dynamic assignment is increased as the communication quality is higher. Thereby, since it is possible to reduce and optimize both of the empty resources at retransmission and overhead by dynamic assignment, it improves frequency usage efficiency.

The following is summary of the assigning method determination procedure and the assigning method changing procedure of the wireless communication apparatus (base station) according to the first embodiment stated above. That is, the number of retransmissions by fixed assignment is controlled so as to be increased as the communication quality level is lower and so as to be decreased as the communication quality level is higher, and that retransmissions over the number of retransmissions are dynamically assigned. However, it is also possible to use the assigning method determination procedure and the assigning method changing procedure as described below in combination. That is, the number of retransmissions by fixed assignment is controlled, based on a moving speed of the communication counterpart (terminal), so as to be increased as the moving speed is higher and so as to be decreased as the moving speed is lower, and retransmissions over the number of retransmissions are dynamically assigned. The following is a further description of a case to use the assigning method determination procedure and the assigning method changing procedure, which can be used in combination as stated above, singularly.

### Second Embodiment

Next, a second embodiment according to the present invention is described with reference to the accompanying drawings.

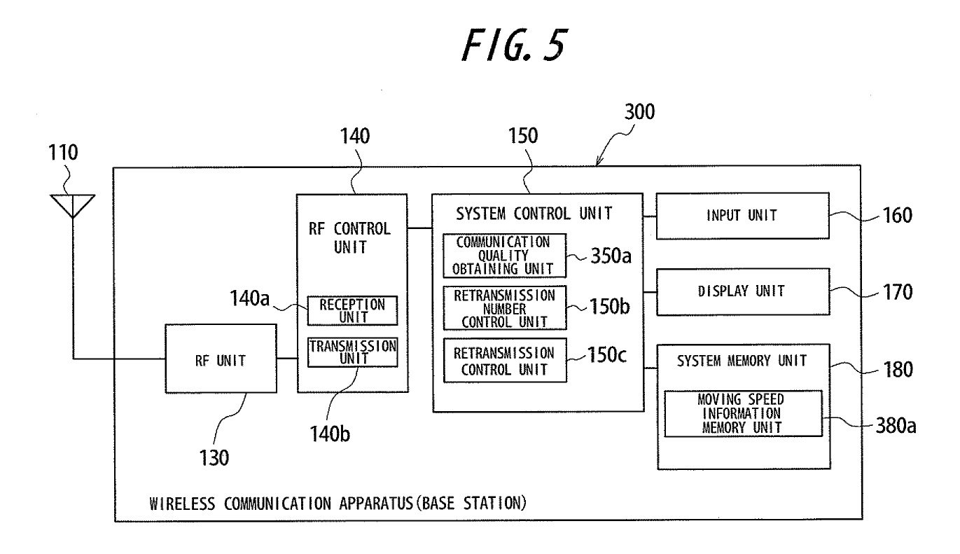

FIG. 5 is a block diagram illustrating a schematic constitution of a wireless communication apparatus according to the second embodiment of the present invention. A wireless communication apparatus (base station) 300 according to the second embodiment can perform data communication corresponding to a predetermined communication scheme (LTE, for example). The wireless communication apparatus (base station) 300 according to the second embodiment has the same constitution as the wireless communication apparatus (base station) 100 according to the first embodiment stated above, except for configurations of the system control unit 150 and the system memory unit 180. Accordingly, function blocks with the same functions as those of the wireless communication apparatus (base station) 100 according to the first embodiment shown in FIG. 1 have the same reference signs.

As shown in FIG. 5, the wireless communication apparatus (base station) 300 has the antenna 110, the RF unit 130, the RF control unit 140, the system control unit 150, the input unit 160, the display unit 170, the system memory unit 180 and the like. The RF control unit 140 has the reception unit 140a and the transmission unit 140b. In the wireless communication apparatus (base station) 300 according to the second embodiment, the system control unit 150 has a moving speed obtaining unit 350a, the retransmission number control unit 150b and the retransmission control unit 150c. The system memory unit 180 has a moving speed information memory unit 380a.

The RF unit 130 converts data to be transmitted by the predetermined communication scheme into a high frequency signal and transmits the high frequency signal from the antenna 110, as well as converting a high frequency signal input from the antenna 110 into a data signal. The RF control unit 14 controls communication (transmission and reception) of the predetermined communication scheme and measures field strength (RSSI and the like) of a signal received by the antenna from the wireless communication apparatus (terminal) of a communication counterpart. In addition, the RF control unit 140 functions as the reception unit 140a and the transmission unit 140b correspondingly to the data signal input from the RF unit 130 and the data signal output to the RF unit 130.

The system control unit 150 functions as a control unit for controlling all units of the base station 300.

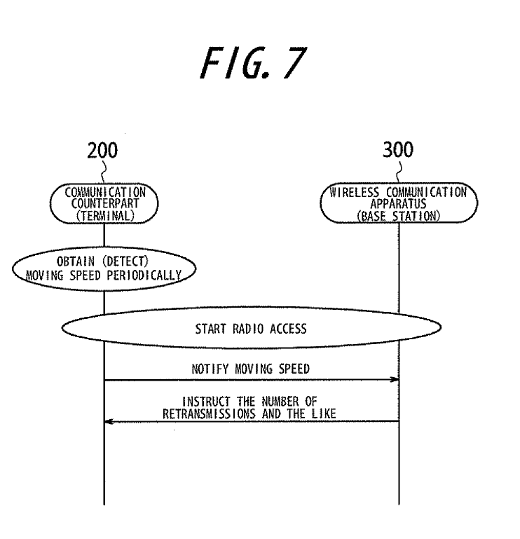

The moving speed obtaining unit 350a obtains the moving speed of the communication counterpart (terminal). The moving speed obtained by the moving speed obtaining unit 350a is stored as moving speed information in the moving speed information memory unit 380a of the system memory unit 180. At that time, the moving speed obtaining unit 350a obtains the moving speed of the communication counterpart (terminal) by being notified of the moving speed of the communication counterpart (terminal), measured by the communication counterpart (terminal), in a sequence in FIG. 7 described below.

The moving speed obtaining unit 350a determines which one of a plurality of speed ranges, for example, a very slow range (under 1 km/h), a slow range (1-5 km/h), a medium range (5-80 km/h), a fast range (80 km/h or over), . . . , the moving speed of the communication counterpart (terminal) corresponds to. The retransmission number control unit 150 classifies the moving speed determined by the moving speed obtaining unit 350a in such a manner to one of “very slow”, “slow”, “medium”, “fast”, . . . . Here, “very slow” is the moving speed at which the highest communication quality is expected, “slow” is the moving speed at which the next highest communication quality is expected, and the communication quality is deteriorated as the moving speed becomes higher in order of “medium”, “fast”, . . . .

Table 2 shows exemplary definitions of speed ranges of the moving speeds stated above. In the example shown in Table 2, it is defined as “very slow” when transmission of equal to or over 50% is succeeded with zero retransmission (without retransmission). In addition, it is defined as “slow” when transmission of equal to or over 50% is succeeded with one retransmission, whereas it is defined as “medium” when transmission of equal to or over 50% is succeeded with two retransmissions. It is defined as “fast” when transmission of equal to or over 50% is succeeded with three retransmissions. “Very fast” and the like may be defined in the same manner as stated above, as necessary.

Definitions of the communication quality levels shown in Table 2 are not limited to the above description but may be modified in a variety of manners, as necessary. For example, if a priority is put on “reduction in overhead in dynamic assignment” than “reduction in empty resources when there is no retransmission”, “50%” in the above definitions of the speed ranges of the moving speeds is replaced with “a predetermined value under 50%”. In contrast, if a priority is put on “reduction in empty resources when there is no retransmission” than “reduction in overhead in dynamic assignment”, “50%” in the above definitions of the speed ranges of the moving speeds is replaced with “a predetermined value over 50%”. It is to be noted that, in consideration of that “a relationship between the moving speed and the communication quality” differs in each communication method adopted to the wireless communication apparatus according to the second embodiment, an upper limit and a lower limit of each speed range of the moving speed shown in Table 2 may be appropriately set so as to be optimum values for an adopted communication method.

TABLE 2

| Moving Speed of | |
|---|---|
| Communication counterpart | |
| (Terminal) | Definition |
| Very Slow (under 1 km/h) | transmission of equal to or over 50% is |
| | succeeded with 0 retransmission |
| Slow (1-5 km/h) | transmission of equal to or over 50% is |
| | succeeded with 1 retransmission |
| Medium (5-80 km/h) | transmission of equal to or over 50% is |
| | succeeded with 2 retransmissions |
| Fast (80 km/h and over) | transmission of equal to or over 50% is |
| | succeeded with 3 retransmissions |
| . | . |
| . | . |
| . | . |

Based on the moving speed of communication counterpart (terminal) obtained by the moving speed obtaining unit 350a, the retransmission number control unit 150b controls the number of retransmissions at the predetermined first frequency.

Particularly, the retransmission number control unit 150b sets the number of retransmissions by fixed assignment based on a relationship between the moving speed of the communication counterpart (terminal) and the number of retransmission times shown in Table 2. At this point, as shown in Table 2, the retransmission number control unit 150b controls such that the number of retransmissions is increased as the moving speed of the communication counterpart (terminal) obtained by the moving speed obtaining unit 350a is faster and the number of retransmissions is decreased as the moving speed of the communication counterpart (terminal) obtained by the moving speed obtaining unit 350a is slower. Also, if the moving speed of the communication counterpart (terminal) obtained by the moving speed obtaining unit 350a is under a predetermined speed (under 1 km/h in Table 2), the retransmission number control unit 150b controls the number of retransmissions to be zero such that retransmission at the first frequency is stopped.

The retransmission control unit 150c controls such that retransmission is performed at the first frequency as many times as the number of retransmissions controlled by the retransmission number control unit 150b and retransmission over the number of retransmissions controlled by the retransmission number control unit 150b is performed at a second frequency which is arbitrarily set with the communication counterpart (terminal). In this case, the second frequency may be either different from or the same as the first frequency. In addition, if the retransmission number control unit 150b controls the number of retransmissions to be zero such that retransmission at the first frequency is stopped, the retransmission control unit 150c performs all retransmissions at the second frequency (all retransmissions by dynamic assignment).

The input unit 160 has a variety of keys and buttons and is used for inputting information or for selecting either one of options displayed on a display screen of the display unit 170. The input unit 160 and the display unit 170 may be omitted if desired.

The system memory unit 180 is a memory such as RAM and the like and stores an application program and temporary data. The moving speed information memory unit 380a stores the moving speed of the communication counterpart (terminal) obtained by the moving speed obtaining unit 350a as the moving speed information of one of “very slow”, “slow”, “medium”, “fast”, . . . .

Next, a communication counterpart (terminal) 200 to communicate with the wireless communication apparatus (base station) 300 according to the second embodiment is described. The wireless communication apparatus (base station) 300 according to the second embodiment performs communication with the communication counterpart (terminal) 200, which is a wireless communication terminal having “a moving speed obtaining unit with a function to obtain (detect) the moving speed of the terminal at predetermined intervals”. Particularly, the communication counterpart (terminal) 200 is the wireless communication terminal configured to obtain (detect) periodically the moving speed of the terminal by using one of the following two moving speed detection methods.

[Moving Speed Detection Method 1: Method Using Location Information Obtained By GPS]

A travel distance is calculated from location information at previous monitoring and location information at present monitoring which are obtained by GPS, and a moving speed is detected (calculated) from a difference between previous time and present time. For example, in the north hemisphere, it is defined that t0(h) represents a previous monitoring time, t1 (h) represents a present monitoring time, a degree of longitude and a degree of latitude at t0 are x0 and y0, respectively, and a degree of longitude and a degree of latitude at t1 are x1 and y1, respectively. In this case, a travel distance r(km) and a moving speed v(km/h) may be obtained by the following formulas (1) and (2), respectively.

$$\begin{matrix}[ Formula 1 ] & \\ r = \sqrt{{( ( {y}_{1} - {y}_{0} ) \times cos ( \frac{π}{180} \times {x}_{0} ) )}^{2} + {( {x}_{1} - {x}_{0} )}^{2}} \times \frac{10002}{90} & ( 1 ) \\ [ Formula 2 ] & \\ v = \frac{r}{{t}_{1} - {t}_{0}} & ( 2 )\end{matrix}$$

[Moving Speed Detection Method 2: Method Using Doppler Shift of Frequency of Base Station of Communication Counterpart or Neighboring Base Station]

Generally, a moving object moving at the moving speed v to the base station in a static condition observes a frequency f′ as shown in the following Formula 3 to a radio frequency f transmitted from the base station.

$$\begin{matrix}[ Formula 3 ] & \\ {f}^{′} = f \times \frac{c - v}{c} & ( 3 )\end{matrix}$$

where, e is the speed of light (speed of radio wave). The moving speed v of the moving object may be obtained by the following Formula 4 from the above Formula 3.

$$\begin{matrix}[ Formula 4 ] & \\ v = ( 1 - \frac{{f}^{′}}{f} ) \times c & ( 4 )\end{matrix}$$

Since the moving speed v of the moving object is a speed when the moving object is moving in a direction of the base station, a relationship shown in the following Formula 5 is satisfied when the moving object moves in a direction of an average angle θ from the direction of the base station.

$$\begin{matrix}[ Formula 5 ] & \\ vcos θ = ( 1 - \frac{{f}^{′}}{f} ) \times c & ( 5 )\end{matrix}$$

Here, since a value of θ cannot be determined if only a frequency of the base station of the communication counterpart is observed, it is assumed that θ=π/4, which is a median of 0≦θ≦π/2, so as to calculate the moving speed v by using the following Formula 6.

$$\begin{matrix}[ Formula 6 ] & \\ v = \vert ( 1 - \frac{{f}^{′}}{f} ) \times c \times \frac{1}{cos π / 4} \vert = \vert ( 1 - \frac{{f}^{′}}{f} ) \times c \times \sqrt{2} \vert & ( 6 )\end{matrix}$$

[Flowchart to Obtain Moving Speed of Communication Counterpart (Terminal)]

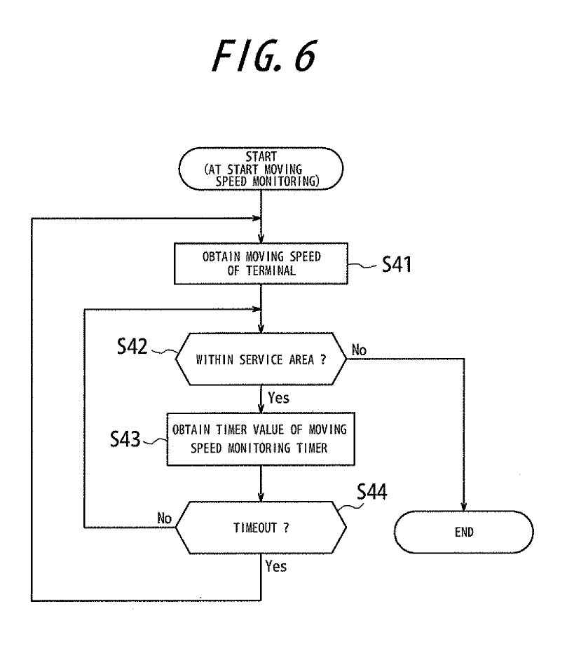

FIG. 6 is a flowchart of exemplary procedure in which the communication counterpart (terminal) 200 obtains a moving speed to be used with a wireless communication method performed by the wireless communication apparatus (base station) 300 according to the second embodiment. The procedure to obtain the moving speed shown in FIG. 6 is initiated at start of monitoring of the moving speed.

First, at step S41, the communication counterpart (terminal) 200 obtains the moving speed of the terminal by using one of the moving speed detection methods 1 and 2 described above. The moving speed is obtained at step S41, and if it is determined that the terminal is within a service area at S42, a loop of Yes at step S42, step S43, Yes of step S44 and step S41 again is repeated. Thereby, if the terminal is within the service area, an obtained moving speed is updated at predetermined intervals (10 seconds) determined by a timer value (10 seconds, for example) of a moving speed monitoring timer. If the terminal moves out of the service area, obtainment (monitoring) of the moving speed is ended, as communication is disconnected.

[Exemplary Assigning Method Determination Sequence]

FIG. 7 is a diagram of exemplary assigning method determination sequence in the wireless communication method performed by the wireless communication apparatus (base station) according to the second embodiment, in which the wireless communication apparatus (base station) obtains the moving speed of the communication counterpart (terminal) from the terminal and instructs the communication counterpart (terminal) on the number of retransmissions and the like.

As shown in FIG. 7, a radio access is started between the communication counterpart (terminal) 200 and the wireless communication apparatus (base station) 300 while the communication counterpart (terminal) 200 is obtaining (detecting) the moving speed of the terminal itself periodically. If the radio access is started between the communication counterpart (terminal) 200 and the wireless communication apparatus (base station) 300 as stated above, the communication counterpart (terminal) 200 informs the wireless communication apparatus (base station) 300 of the moving speed of the terminal obtained. When receiving the moving speed of the terminal, the wireless communication apparatus (base station) 300 instructs the communication counterpart (terminal) 200 about the number of retransmissions at the predetermined first frequency, an assigning method (fixed assignment or dynamic assignment) and the like.

[Flowchart of Assigning Method Determination Procedure]

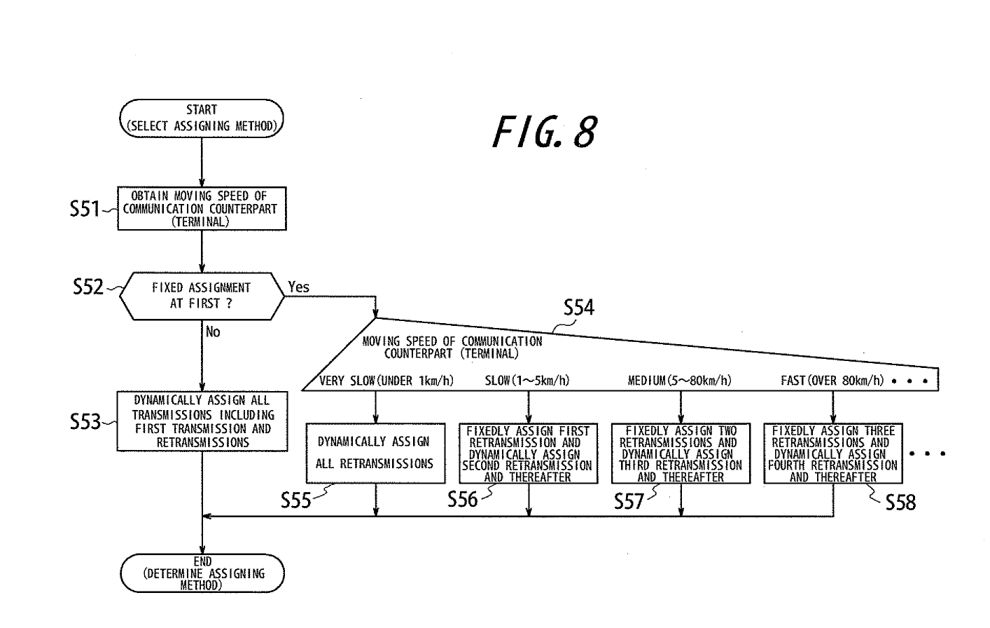

FIG. 8 is a flowchart of exemplary assigning method determination procedure in the wireless communication method performed by the wireless communication apparatus (base station) 300 according to the second embodiment. The assigning method determination procedure shown in FIG. 8 is initiated at start of communication (start of radio access).

First, at step S51, the moving speed obtaining unit 350a obtains the moving speed of the communication counterpart (terminal). Then, at next step S52, the retransmission number control unit 150b determines whether a first transmission of data to the communication counterpart (terminal) is by fixed assignment. If the first transmission is not by fixed assignment at step S52, the retransmission number control unit 150b proceeds to step S53 to dynamically assign all transmissions including the first transmission and retransmissions. In contrast, if the first transmission is by fixed assignment at step S52, the retransmission number control unit 150b proceeds to step S54. At step S52, determination whether the first transmission of the data to the communication counterpart (terminal) is by fixed assignment is performed based on QoS (Quality of Service), for example.

At step S54, the retransmission number control unit 150b, based on the moving speed of the communication counterpart (terminal) obtained at step S51, fixedly assigns retransmissions as many times as the number of retransmissions at the predetermined first frequency and dynamically assigns retransmission over the number of retransmission at the second frequency. That is, at step S54, the retransmission number control unit 150b first determines which one of “very slow”, “slow”, “medium”, “fast”, . . . the moving speed of the communication counterpart (terminal) obtained at step S51 corresponds to. Then, based on such determination, the retransmission number control unit 150b proceeds to step S55 if the moving speed corresponds to “very slow”, to step S56 if the moving speed corresponds to “slow”, to step S57 if the moving speed corresponds to “medium” and to step S58 if the moving speed corresponds to “fast”, so as to perform processing at each of the steps.

In case of “very slow”, which is expected to provide the highest communication quality, the process flow proceeds to step S55, where since the communication quality is excellent and a probability to generate retransmission is low and thus generation of an empty resource is reduced, dynamic assignment for all retransmissions can provide effective communication. In consideration of that, the retransmission number control unit 150b controls the number of retransmissions to be zero such that retransmission (by fixed assignment) at the predetermined first frequency is stopped, and dynamically assigns all retransmissions at the second frequency. In case of “slow”, expected to provide the second highest communication quality, the process flow proceeds to step S56, where the retransmission number control unit 150b limits the number of retransmissions by fixed assignment to one and fixedly assigns first retransmission and then dynamically assigns second retransmission and retransmissions thereafter. In case of “medium”, which may possibly be an environment with a deteriorated communication quality, the process flow proceeds to step S57, where the retransmission number control unit 150b limits the number of retransmissions by fixed assignment to two and fixedly assigns two retransmissions and then dynamically assigns third retransmission and retransmissions thereafter. In case of “fast”, which may highly possibly be an environment with a deteriorated communication quality, the process flow proceeds to step S58, where the retransmission number control unit 150b limits the number of retransmissions by fixed assignment to three and fixedly assigns three retransmissions and then dynamically assigns fourth retransmission and retransmissions thereafter.

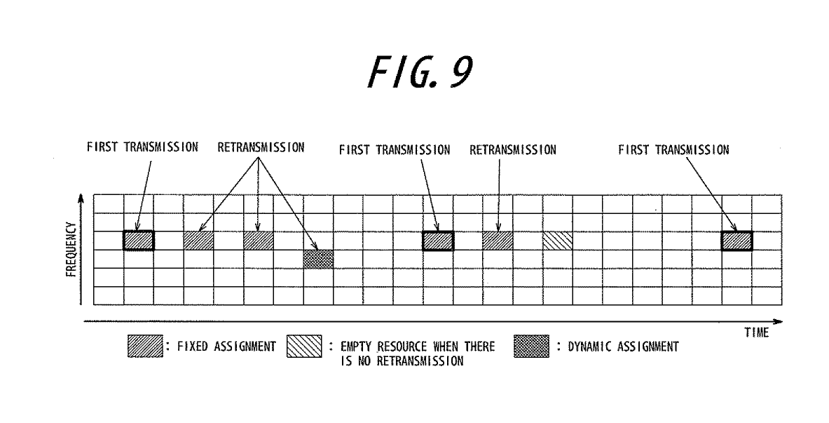

FIG. 9 is a diagram illustrating an exemplary operation of the assigning method determination procedure described with reference to FIG. 8. FIG. 9 shows “an example of operation of exemplary scheduling to fixedly assign two retransmissions and dynamically assign retransmissions thereafter”. In a first transmission period in FIG. 9, corresponding to step S57 in FIG. 8, data are retransmitted twice by fixed assignment to the communication counterpart after a first transmission and then retransmitted once by dynamic assignment. Therefore, no empty resource without retransmission is generated and retransmission of data with dynamic assignment is performed only once. Accordingly, the overhead in FIG. 9 is reduced to amount for one dynamic assignment, although the overhead in dynamic assignment of the conventional example 2 shown in FIG. 12 is for two dynamic assignments. In addition, in a next transmission period in FIG. 9, corresponding to step S57 in FIG. 8, data are retransmitted by fixed assignment to the communication counterpart only once after first transmission. Therefore, while one empty resource without retransmission is generated in FIG. 9, the number of empty resources is dramatically decreased in comparison with the conventional example 1 shown in FIG. 11, which has the empty resources for three retransmissions.

According to the wireless communication apparatus (base station) and the wireless communication method performed by the wireless communication apparatus (base station) according to the second embodiment, the assigning method determination procedure shown in FIG. 8 is performed. That is, at start of communication, the number of retransmissions by fixed assignment is controlled according to a moving speed of the communication counterpart (terminal) to be increased as the moving speed of the communication counterpart (terminal) is faster and to be decreased as the moving speed of the communication counterpart (terminal) is slower, and retransmissions only as many times as the number of retransmissions is performed at the predetermined first frequency. On the other hand, with regard to retransmissions over the number of retransmissions, the number of retransmissions by dynamic assignment is controlled to be increased as the moving speed of the communication counterpart (terminal) is slower and retransmissions only as many times as the number of retransmissions by dynamic assignment are performed at the second frequency arbitrarily set with the communication counterpart (terminal). Accordingly, according to the second embodiment, the number of retransmissions by fixed assignment is increased as the communication quality is more deteriorated with increase in the moving speed of the terminal (terminal). Also, according to the second embodiment, the number of retransmissions by fixed assignment is decreased and the number of retransmissions by dynamic assignment is increased, as the communication quality is better with reduction in the moving speed of the communication counterpart (terminal). Thereby, since it is possible to reduce and optimize both of the empty resources at retransmission and overhead by dynamic assignment, it improves frequency usage efficiency.

[Flowchart of Assigning Method Changing Procedure]

According to the assignment method determination procedure shown in FIG. 8, a timing to determine the assigning method is at start of communication. However, it is preferred that the assigning method determined at start of communication can be changed during communication (when transmission packets are generated) in accordance with change in the communication quality thereafter.

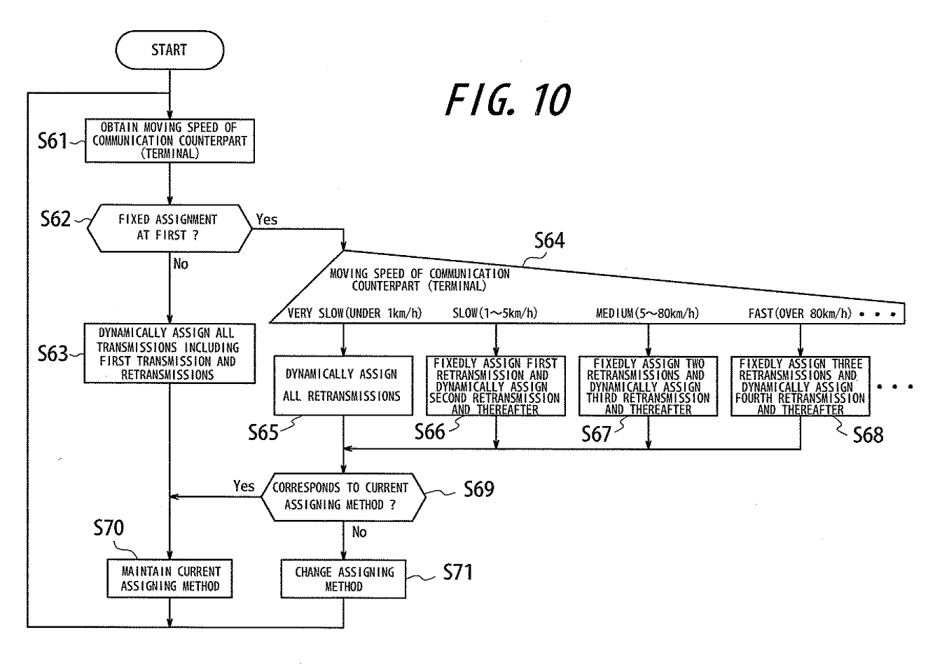

FIG. 10 is a flowchart of exemplary assigning method changing procedure in the wireless communication method performed by the wireless communication apparatus (base station) 300 according to the second embodiment. The assigning method changing procedure shown in FIG. 10 changes the assigning method determined in the assigning method determination procedure shown in FIG. 8 in accordance with change in the communication quality and is performed at predetermined intervals.

In the above assigning method changing procedure, first, the moving speed obtaining unit 350a obtains the moving speed of the communication counterpart (terminal) at step S61. Then, at step S62, the retransmission number control unit 150b determines whether a first transmission of data to the communication counterpart (terminal) is by fixed assignment. If the first transmission is not by the fixed assignment at step S62, the retransmission number control unit 150b proceeds to step S63 to dynamically assign all transmissions including the first transmission and retransmissions. In contrast, if the first transmission is by fixed assignment at step S62, the retransmission number control unit 150b proceeds to step S64. At step S62, determination whether the first transmission of the data to the communication counterpart (terminal) is by fixed assignment is performed based on QoS (Quality of Service), for example.

At step S64, the retransmission number control unit 150b, based on the moving speed of the communication counterpart (terminal) obtained by the moving speed obtaining unit 350a at step S61, fixedly assigns the number of retransmissions at the predetermined first frequency and dynamically assigns retransmission over the number of retransmission at the second frequency. That is, at step S64, the retransmission number control unit 150b first determines which one of “very slow”, “slow”, “medium”, “fast”, . . . the moving speed of the communication counterpart (terminal) obtained at step S61 corresponds to. Then, based on such determination, the retransmission number control unit 150b proceeds to step S65 if the moving speed corresponds to “very slow”, to step S66 if the moving speed corresponds to “slow”, to step S67 if the moving speed corresponds to “medium” and to step S68 if the moving speed corresponds to “fast”, so as to perform processing at each of the steps.

In case of “very slow”, which is expected to provide the highest communication quality, the process flow proceeds to step S65, where since communication quality is excellent and a probability to generate retransmission is low and thus generation of an empty resource is decreased, dynamic assignment for all retransmissions can provide effective communication. In consideration of that, the retransmission number control unit 150b controls the number of retransmissions to be zero such that retransmission (by fixed assignment) on the predetermined first frequency is stopped, and dynamically assigns all retransmissions at the second frequency. In case of “slow”, expected to provide the second highest communication quality, the process flow proceeds to step S66, where the retransmission number control unit 150b limits the number of retransmissions by fixed assignment to one and fixedly assigns first retransmission and then dynamically assigns second retransmission and retransmissions thereafter. In case of “medium”, which may possibly be an environment with a deteriorated communication quality, the process flow proceeds to step S67, where the retransmission number control unit 150b limits the number of retransmissions by fixed assignment to two and fixedly assigns two retransmissions and then dynamically assigns third retransmission and retransmissions thereafter. In case of “fast”, which may highly possibly be an environment with a deteriorated communication quality, the process flow proceeds to step S68, where the retransmission number control unit 150b limits the number of retransmissions by fixed assignment to three and fixedly assigns three retransmissions and then dynamically assigns fourth retransmission and retransmissions thereafter.

At next step S69, the retransmission number control unit 150b determines whether the assigning method determined at step S65, step S66, step S67 or step S68 corresponds to a current assigning method. At step S69, if the current assigning method corresponds to the assigning method determined at a previous step (step S65, step S66, step S67 or step S68), the retransmission number control unit 150b proceeds to step S70 to maintain the current assigning method. In contrast, at step S69, if the current assigning method does not correspond to the assigning method determined at the previous step, the retransmission number control unit 150b proceeds to step S71 to switch to the assigning method determined at step S65, step S66, step S67 or step S68. After execution of step S70 or S71, the retransmission number control unit 150b returns to step S61 to repeat the assigning method changing procedure stated above. Therefore, when transmission packets are generated, the assigning method is changed in accordance with change in the communication quality, as necessary.

According to the wireless communication apparatus (base station) and the wireless communication method performed by the wireless communication apparatus (base station) according to the second embodiment, the assigning method determination procedure shown in FIG. 10 is performed. That is, not only at start of communication but also during communication, the number of retransmission by fixed assignment is controlled so as to be increased as the moving speed of the communication counterpart (terminal) is faster and so as to be decreased as the moving speed of the communication counterpart (terminal) is slower, and retransmissions only as many times as the number of retransmissions is performed at the predetermined first frequency. On the other hand, with regard to retransmissions over the number of retransmissions, the number of retransmissions by dynamic assignment is controlled to be increased as moving speed of the communication counterpart (terminal) is faster and retransmissions only as many times as the number of retransmissions by dynamic assignment are performed at the second frequency arbitrarily set with the communication counterpart (terminal). Accordingly, according to the second embodiment, the number of retransmissions by fixed assignment is increased as the communication quality is more deteriorated with increase in the moving speed of the terminal (terminal). Also, according to the second embodiment, the number of retransmissions by fixed assignment is decreased and the number of retransmission by dynamic assignment is increased, as the communication quality is better with reduction in the moving speed of the communication counterpart (terminal). Thereby, since it is possible to reduce and optimize both of the empty resources at retransmission and overhead by dynamic assignment, it improves frequency usage efficiency.

The following is summary of the assigning method determination procedure and the assigning method changing procedure of the wireless communication apparatus (base station) according to the second embodiment described above. That is, the number of retransmission by fixed assignment is controlled so as to be increased as the moving speed of the communication counterpart (terminal) is faster and so as to be decreased as the moving speed of the communication counterpart (terminal) is slower, and that retransmissions over the number of retransmissions are dynamically assigned. However, it is also possible to use the assigning method determination procedure and the assigning method changing procedure as described in the above first embodiment in combination. That is, the assigning method determination procedure and the assigning method changing procedure, in which the number of retransmissions by fixed assignment is controlled so as to be increased as the communication quality level is lower and so as to be decreased as the communication quality level is higher and retransmissions over the number of retransmissions are dynamically assigned, may be used in combination with the present embodiment.

### INDUSTRIAL APPLICABILITY

According to the present invention, the number of retransmissions at the predetermined first frequency is controlled, based on the communication quality of the radio propagation path with the communication counterpart, so as to be decreased as the communication quality is higher, for example. In addition, according to the present invention, it is controlled such that retransmissions over the number of retransmissions are performed at the second frequency arbitrarily set with the communication counterpart. According to the present invention, for example, the number of retransmissions by fixed assignment is increased as the communication quality is more deteriorated, whereas the number of retransmissions by fixed assignment is decreased as the communication quality is better and the number of retransmissions by dynamic assignment is increased. Thereby, it is possible to reduce both of the empty resources at retransmission and overhead by dynamic assignment. In addition, it is also possible to optimize both of the empty resources at retransmission and overhead by dynamic assignment and thus to improve frequency usage efficiency.

Moreover, according to the present invention, the number of retransmissions at the predetermined first frequency is controlled, based on the moving speed of the communication counterpart, so as to be decreased as the moving speed of the communication counterpart is slower, for example. In addition, according to the present invention, it is controlled such that retransmissions over the number of retransmissions are performed at the second frequency arbitrarily set with the communication counterpart. According to the present invention, for example, the number of retransmissions by fixed assignment is increased as the moving speed of the communication counterpart is faster, whereas the number of retransmissions by fixed assignment is decreased as the moving speed of the communication counterpart is slower and the number of retransmissions by dynamic assignment is increased. Thereby, it is possible to reduce both of the empty resources at retransmission and overhead by dynamic assignment. In addition, it is also possible to optimize both of the empty resources at retransmission and overhead by dynamic assignment and thus to improve frequency usage efficiency.

### REFERENCE SIGNS LIST

100, 300 wireless communication apparatus (base station)
110 antenna
130 RF unit
140 RF control unit
140a reception unit
140b transmission unit
150 system control unit
150a communication quality obtaining unit
150b retransmission number control unit
150c retransmission control unit
160 input unit
170 display unit
180 system memory unit
180a communication quality infouiiation memory unit
200 communication counterpart (terminal)
350a moving speed obtaining unit
380b moving speed information memory unit

1. A wireless communication apparatus for performing retransmission of data to a communication counterpart by using a predetermined frequency comprising:
a communication quality obtaining unit for obtaining communication quality of a radio propagation path with the communication counterpart;
a retransmission number control unit for controlling a number of retransmissions at a predetermined first frequency based on the communication quality obtained by the communication quality obtaining unit; and
a retransmission control unit for controlling the retransmission such that retransmission over the number of retransmissions controlled by the retransmission number control unit is performed at a second frequency set with the communication counterpart.

2. The wireless communication apparatus according to claim 1, wherein the retransmission number control unit controls the number of retransmissions to be decreased as the communication quality obtained by the communication quality obtaining unit is higher.

3. The wireless communication apparatus according to claim 1, wherein the retransmission number control unit controls the number of retransmissions such that retransmission at the first frequency is stopped if the communication quality obtained by the communication quality obtaining unit exceeds a predetermined communication quality.

4. A wireless communication method for performing retransmission of data to a communication counterpart by using a predetermined frequency comprising the steps of
obtaining communication quality of a radio propagation path with the communication counterpart;
controlling a number of retransmissions at a predetermined first frequency based on the communication quality obtained at the step of obtaining the communication quality; and
controlling the retransmission such that retransmission over the number of retransmissions controlled at the step of controlling the number of retransmissions is performed at a second frequency set with the communication counterpart.

5. A wireless communication apparatus for performing retransmission of data to a communication counterpart by using a predetermined frequency comprises:
a moving speed obtaining unit for obtaining a moving speed of the communication counterpart;
a retransmission number control unit for controlling a number of retransmissions at a predeteiuiined first frequency based on the moving speed of the communication counterpart obtained by the moving speed obtaining unit; and
a retransmission control unit for controlling the retransmission such that retransmission over the number of retransmissions controlled by the retransmission number control unit is performed at a second frequency set with the communication counterpart.

6. The wireless communication apparatus according to claim 5, wherein the retransmission number control unit controls the number of retransmissions to be decreased as the moving speed of the communication counterpart obtained by the moving speed obtaining unit is slower.

7. The wireless communication apparatus according to claim 5, wherein the retransmission number control unit controls the number of retransmissions such that retransmission at the first frequency is stopped if the moving speed of the communication counterpart obtained by the moving speed obtaining unit is slower than a predetermined speed.

8. The wireless communication apparatus according to claim 5, wherein the moving speed obtaining unit obtains the moving speed of the communication counterpart by being notified of the moving speed of the communication counterpart measured by the communication counterpart.

9. A wireless communication method for performing retransmission of data to a communication counterpart by using a predetermined frequency comprising the steps of:
obtaining a moving speed of the communication counterpart;
controlling a number of retransmissions at a predetermined first frequency based on the moving speed of the communication counterpart obtained at the step of obtaining the moving speed; and
controlling the retransmission such that retransmission over the number of retransmissions controlled at the step of controlling the number of retransmissions is performed at a second frequency set with the communication counterpart.

10. The wireless communication apparatus according to claim 2, wherein the retransmission number control unit controls the number of retransmissions such that retransmission at the first frequency is stopped if the communication quality obtained by the communication quality obtaining unit exceeds a predetermined communication quality.

11. The wireless communication apparatus according to claim 6, wherein the retransmission number control unit controls the number of retransmissions such that retransmission at the first frequency is stopped if the moving speed of the communication counterpart obtained by the moving speed obtaining unit is slower than a predetermined speed.

12. The wireless communication apparatus according to claim 6, wherein the moving speed obtaining unit obtains the moving speed of the communication counterpart by being notified of the moving speed of the communication counterpart measured by the communication counterpart.

13. The wireless communication apparatus according to claim 7, wherein the moving speed obtaining unit obtains the moving speed of the communication counterpart by being notified of the moving speed of the communication counterpart measured by the communication counterpart.

14. The wireless communication apparatus according to claim 11, wherein the moving speed obtaining unit obtains the moving speed of the communication counterpart by being notified of the moving speed of the communication counterpart measured by the communication counterpart.
